(19) United States
(12) Patent Application Publication
(10) Pub. No.: US 2024/0289115 A1
(43) Pub. Date: Aug. 29, 2024

(54) INFORMATION PROCESSING SYSTEM, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Tomoaki MIYAZAWA, Nagoya-shi (JP); Ryota NAKABAYASHI, Nagoya-shi (JP); Naoki YOMODA, Toyota-shi (JP); Atsushi MORI, Miyoshi-shi (JP); Hiroshi INOUE, Nagoya-shi (JP); Tsukasa KITAZAWA, Toyota-shi (JP)

(73) Assignee: TOYOTA JIDOSHA KABUSHIKI KAISHA, Toyota-shi (JP)

(21) Appl. No.: 18/406,254

(22) Filed: Jan. 8, 2024

(30) Foreign Application Priority Data
Feb. 24, 2023 (JP) 2023-027076

(51) Int. Cl. G06F 8/65

(52) U.S. Cl. CPC G06F 8/65

(57) ABSTRACT

An information processing system includes one or more processors configured to: determine whether an update of software in a vehicle is capable of being started at a planned start time of the update, before the planned start time; and alter the planned start time when the one or more processors determine that the update is not capable of being started at the planned start time.

### CROSS-REFERENCE TO RELATED APPLICATION

This application claims priority to Japanese Patent Application No. 2023-027076 filed on Feb. 24, 2023, incorporated herein by reference in its entirety.

### BACKGROUND

### 1. Technical Field

The present disclosure relates to an information processing system, an information processing method, and a non-transitory storage medium.

### 2. Description of Related Art

Japanese Unexamined Patent Application Publication No. 2012-14253 describes an information processing system that generates an update schedule for software in a vehicle, based on the usage status of the vehicle.

### SUMMARY

In some cases, the update of the software cannot be executed in accordance with the schedule. In such cases, a user knows later that the software has not been updated. As a result, the convenience for the user can decrease.

An information processing system according to a first aspect of the present disclosure includes one or more processors configured to: determine whether an update of software in a vehicle is capable of being started at a planned start time of the update, before the planned start time; and alter the planned start time when the one or more processors determine that the update is not capable of being started at the planned start time.

An information processing method according to a second aspect of the present disclosure includes: determining whether an update of software in a vehicle is capable of being started at a planned start time of the update, before the planned start time; and altering the planned start time when it is determined that the update is not capable of being started at the planned start time.

A non-transitory storage medium according to a third aspect of the present disclosure stores instructions that are executable by one or more processors and cause the one or more processors to perform the information processing method according to the second aspect.

The convenience for the user about the software update in the vehicle is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the configuration of an embodiment of an information processing system; and

FIG. 2 is a flowchart of an automatic alteration routine for a planned start time that is executed by the information processing system.

### DETAILED DESCRIPTION OF EMBODIMENTS

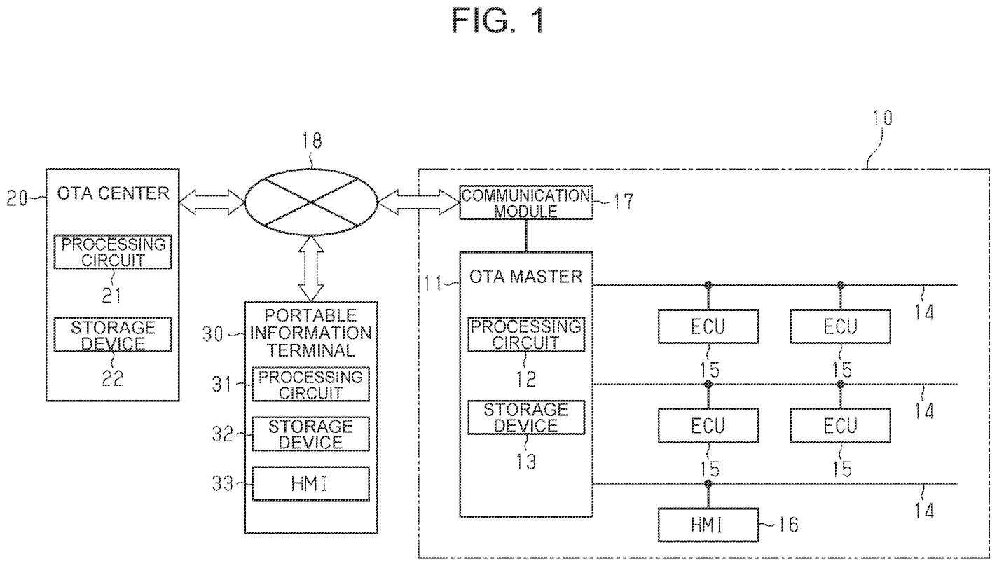

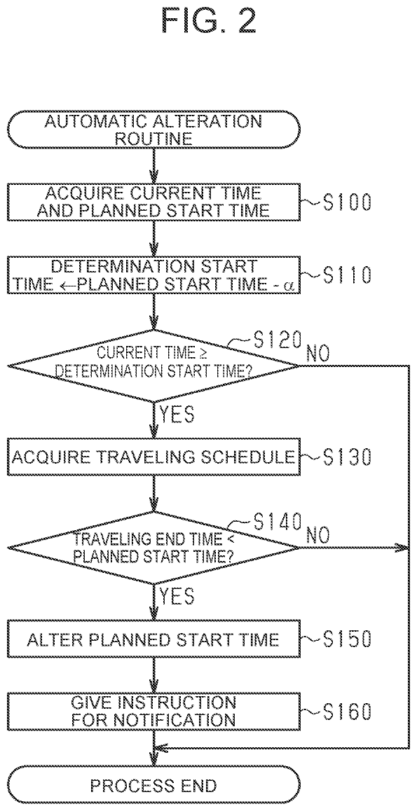

An embodiment of an information processing system, an information processing method, and an information processing program will be described below in detail with reference to FIG. 1 and FIG. 2.

### Configuration of Information Processing System

First, the configuration of the information processing system in the embodiment will be described with reference to FIG. 1. The information processing system in the embodiment is a system that processes information relevant to the software update in a vehicle 10.

The vehicle 10 is equipped with various electronic control units (ECUs) 15 that control parts of the vehicle 10, and an OTA master 11 that manages the software update in the vehicle 10. Examples of the ECU 15 include an engine ECU, a transmission ECU, a brake ECU, an advanced driving assist ECU, and a multimedia ECU. The OTA master 11 includes a processing circuit (one or more processors) 12 and a storage device (one or more memories) 13. In the storage device 13, a program for the management of the software update is previously stored. The OTA master 11 is configured to perform a process relevant to the management of the software update, by causing the processing circuit 12 to read and execute the program stored in the storage device 13. The OTA master 11 is connected with a communication module 17 for performing vehicle exterior communication through a mobile communication network 18. Furthermore, the vehicle 10 is equipped with a human-machine interface (HMI) 16. The HMI 16 includes an input device that accepts an operation by an occupant, and an output device that presents information to the occupant through an image and a voice. The HMI 16 in the embodiment has a navigation function to perform guidance about a traveling route of the vehicle 10. The OTA master 11, the ECUs 15, and the HMI 16 are configured to be capable of communicating with each other through in-vehicle communication lines 14.

The update of the software in the vehicle 10 is performed based on the update date delivered from an OTA center 20 through the mobile communication network 18 or the like. The OTA center 20 is a server device that includes a processing circuit (one or more processors) 21 and a storage device (one or more memories) 22. The OTA center 20 is configured to be capable of communicating with the exterior through the mobile communication network 18.

The OTA center 20 is configured to be capable of mutually communicating also with a portable information terminal 30 of a user of the vehicle 10, through the mobile communication network 18 and the like. The portable information terminal 30 includes a processing circuit (one or more processors) 31, a storage device (one or more memories) 32, and an HMI 33. The processing circuit 31 reads and executes programs stored in the storage device 32. The programs stored in the storage device 13 include a program for vehicle management.

### Preparation Process for Software Update

Next, a process for preparing the software update in the vehicle 10 will be described. A case of updating software for one of the ECUs 15 equipped in the vehicle 10 will be described as an example. However, the object of the software update may be an in-vehicle electronic apparatus other than the ECUs 15, and for example, may be the HMI 16, sensors, or the like.

The software update is performed after the completion of the preparation. The preparation for the software update is performed in a download phase and an install phase.

In the download phase, the update data for the software is downloaded from the OTA center 20 to the OTA master 11. In the download phase, the OTA master 11 receives the update data for the software from the OTA center 20. Then, the OTA master 11 stores the received update data in the storage device 13. In the download phase, a sequence of processes relevant to the download, as exemplified by the determination of whether the download can be executed, and the verification of the update data, is included. The update data that is sent from the OTA center 20 to the OTA master 11 may include update software, may include compressed data in which the update software is compressed, or may include divided data in which the update software or the compressed data is divided. Further, the update data may include an identifier for the in-vehicle electronic apparatus that is the update object and an identifier for the software before the update. The update data is downloaded as a delivery package. The delivery package includes the update data for a single or a plurality of in-vehicle electronic apparatuses.

In the install phase, the update software is written in the in-vehicle electronic apparatus that is the update object. In the install phase, the OTA master 11 writes the update software in a non-volatile memory of the ECU 15 that is the update object. In the install phase, a sequence of processes relevant to the install, as exemplified by the determination of whether the install can be executed, the transfer of the update data, and the verification of the update software, is included. In the case where the update date includes the update software itself, the OTA master 11 transfers the update data to the in-vehicle electronic apparatus that is the update object, in the install phase. In the case where the update data includes the compressed data, differential data, or divided data for the update software, a process of generating the update software from the update data is performed. The generation process may be performed by the OTA master 11, or may be performed by the in-vehicle electronic apparatus that is the update object. The generation of the update software can be performed by the decomposition of the compressed data or the assembly of the differential data or the divided data.

After the completion of the install phase, the setting of a planned start time of the software update is performed. The setting of the planned start time is performed in the following procedure, for example. When the update preparation is completed, the OTA master 11 displays a setting screen for the planned start time, on the HMI 16. The user of the vehicle 10 sets the planned start time on the HMI 16 on which the setting screen is displayed, and then, the HMI 16 sends the planned start time set by the user, to the OTA master 11. The OTA master 11 stores the planned start time received from the HMI 16, in the storage device 13.

The setting of the planned start time may be performed on the portable information terminal 30. In this case, the planned start time set on the portable information terminal 30 by the user is sent to the OTA master 11 of the vehicle 10 through the OTA center 20.

### Update Process for Software

Next, the update process for the software will be described. The update process is a process of switching the in-vehicle electronic apparatus that is the update object, from a state where the in-vehicle electronic apparatus operates using the software before the update to a state where the in-vehicle electronic apparatus operates using the software after the update.

At the planned start time set by the user, the OTA master 11 determines whether an execution condition for activation is satisfied. The execution condition is set individually for each type of the in-vehicle electronic apparatus and each piece of update software. In the case of an in-vehicle electronic apparatus that performs a necessary control for the traveling of the vehicle 10, for example, in the case of the engine ECU, the transmission ECU, or the brake ECU, the execution condition for the software update includes a condition that the vehicle 10 is not traveling.

In the case where the execution condition is not satisfied, the OTA master 11 withholds the execution of the update process, and requests the resetting of the planned start time. In the case where the execution condition is satisfied, the OTA master 11 starts the update process. At the time of the update process, the OTA master 11 gives a command for the activation of the update software, to the in-vehicle electronic apparatus that is the update object. In response to this command, the in-vehicle electronic apparatus that is the update object executes the activation. The update process includes a sequence of processes relevant to the activation, as exemplified by the verification of the execution result about the activation.

### Automatic Alteration Process for Planned Start Time

Even at the planned start time, when the execution condition is not satisfied at that time, the update of the software cannot be executed. In response, the OTA master 11 determines whether the update can be started at the planned start time, before the planned start time, and in the case where it is determined that the update cannot be started, the OTA master 11 performs an automatic alteration process for the planned start time by which the planned start time is altered.

FIG. 2 shows a flowchart of an automatic alteration routine that is executed by the OTA master 11 for an automatic alteration process for the planned start time. The automatic alteration process corresponds to the software update for which the execution condition includes a condition that the vehicle 10 is parked. The OTA master 11 repeatedly executes the routine with a predetermined control period, after the setting of the planned start time and before the planned start time.

When the routine starts, the OTA master 11, first, acquires the current time and the planned start time in step S100. Next, in step S110, the OTA master 11 calculates a time of a predetermined time period a before the planned start time, as a determination start time. Subsequently, in step S120, the OTA master 11 determines whether the current time is earlier than the determination start time. In the case where the current time is an earlier time than the determination start time (S120: NO), the OTA master 11 ends the process of the routine for this control period with no change. On the other hand, in the case where the current time is a later time than the determination start time (S120: YES), the OTA master 11 causes the process to proceed to step S130.

In step S130, the OTA master 11 acquires a traveling schedule for the vehicle 10 from the HMI 16. The traveling schedule includes information about a traveling end time. For example, in the case where the HMI 16 performs the traveling route guidance using the navigation function, an expected arrival time for a destination set by the user is used as the traveling end time. The destination for this traveling may be estimated based on the past traveling history, the current time, and the like, and the expected arrival time for the estimated destination may be calculated as the traveling end time.

Subsequently, in step S140, the OTA master 11 determines whether the traveling end time is an earlier time than the planned start time. In the case where the planned start time is earlier than the traveling end time (NO), the OTA master 11 ends the process of the routine for this control period with no change. On the other hand, in the case where the planned start time is later than the traveling end time (YES), it is predicted that the vehicle 10 is traveling at the planned start time. In this case, the OTA master 11 causes the process to proceed to step S150.

In step S150, the OTA master 11 alters the planned start time. For example, the OTA master 11 sets a time after a predetermined time period ß from the traveling end time, as a new planned start time. In this case, after that, the user may manually set the planned start time to a different time.

Then, the OTA master 11 gives an instruction for notification to the HMI 16, in step S160, and thereafter ends the process of the routine for this control period. In response to this instruction, the HMI 116 performs screen display for notifying the user of the alteration of the planned start time.

### Function Effect of Embodiment

The OTA master 11 starts the update of the software for the in-vehicle electronic apparatus, at the planned start time set by the user. However, in the case where the execution condition for the update is not satisfied at the set planned start time, the OTA master 11 withholds the execution of the software update. For example, in the case of an in-vehicle electronic apparatus that performs a control relevant to the traveling of the vehicle 10, the execution condition for the software update includes a condition that the vehicle 10 is not traveling. In the case where the arrival at the destination is delayed because of congestion or the like, the vehicle 10 is still traveling at the planned start time, in some cases. In such cases, the update of the software cannot be started at the planned start time. In such cases, since the update of the software is not executed in accordance with the plan, the convenience for the user can decrease.

In response, the OTA master 11 determines whether the update can be started at the planned start time, before the planned start time. Then, in the case where the OTA master 11 determines that the update cannot be started, the OTA master 11 automatically alters the planned start time.

Operations and effects of the embodiment will be described.
(1) Even when the update of the software cannot be started at the previously set planned start time because the execution condition is not satisfied, the update is automatically executed at a different time, in some cases. Therefore, the convenience for the user is improved.
(2) The OTA master 11 determines whether the update can be started based on the traveling schedule for the vehicle 10. Therefore, it is possible to accurately determine whether the update of the software for which it is determined whether the update can be executed based on the vehicle situation of the vehicle 10 can be started at the planned start time.
(3) The OTA master 11 alters the planned start time based on the traveling schedule for the vehicle 10. Specifically, the OTA master 11 alters the planned start time to a later time than the traveling end time of the vehicle 10. Therefore, it is possible to alter the planned start time to a time at which there is a high possibility that the update can be started.
(4) Before the time of the predetermined time period a before the planned start time, the OTA master 11 does not execute the determination of whether the update can be started at the planned start time and the alteration of the planned start time based on the determination result. The accuracy of the determination of whether the update can be started at the planned start time decreases as the time period to the planned start time is longer. Therefore, the planned start time is unlikely to be needlessly altered.

### Correspondence Relation

In steps S130 and S140 of FIG. 2, the OTA master 11 performs a process of determining whether the update can be started at the planned start time. Further, in step S150 of FIG. 2, the OTA master 11 alters the planned start time. In the embodiment, the OTA master 11 corresponds to the determination unit, the alteration unit, and the information processing system.

### Other Embodiments

### Configuration of Information Processing System

The information processing system may be configured such that the OTA center 20 executes some of the processes of the automatic alteration routine in FIG. 2. For example, the OTA master 11 executes processes until step S140 of FIG. 2, and sends the determination result in step S140, to the OTA center 20. Then, based on the received determination result, the OTA center 20 executes step S150 and subsequent processes of FIG. 2. On this occasion, the OTA center 20 gives the instruction for the notification in step S160 of FIG. 2, to the OTA master 11 of the vehicle 10. Then, based on the instruction, the OTA master 11 causes the HMI 16 to execute the notification. In this case, the OTA master 11 corresponds to the determination unit, and the OTA center 20 corresponds to an instruction unit. Further, the information processing system in this case is constituted by the OTA master 11 and the OTA center 20.
The information processing system may be configured such that the OTA center 20 executes all of the processes of the automatic alternation routine of FIG. 2. The OTA center 20 in this case shares the planned start time with the OTA master 11. Further, the OTA center 20 acquires the traveling schedule from the vehicle 10, and executes the determination in step S130. Also in this case, the OTA center 20 gives the instruction for the notification in step S160 of FIG. 2, to the OTA master 11 of the vehicle 10. Then, based on the instruction, the OTA master 11 causes the HMI 16 to execute the notification. In this case, the OTA center 20 corresponds to the determination unit, the instruction unit, and the information processing system.

### Update Process for Software

In the above embodiment, the install of the update software is performed before the planned start time. The install may be executed at the planned start time, and the update of the software may be started after the completion of the install.

### Automatic Alteration Routine

The determination in steps S110 and S120 of FIG. 2 may be skipped. That is, even at an earlier time than the determination start time, the determination in step S140 and the instruction for the notification in step S160 may be executed.
In step S160 of FIG. 2, the instruction for the notification may be given to the portable information terminal 30 of the user. In this case, the instruction for the notification is sent from the OTA master 11 to the portable information terminal 30 of the user through the OTA center 20.
The instruction for the notification in step S160 may be skipped.

### Alteration of Planned Start Time

In the above embodiment, in the case where the OTA master 11 determines that the update cannot be started at the planned start time, the OTA master 11 alters the planned start time such that the new planned start time is the time after the predetermined time period β from the traveling end time, in step S150 of FIG. 2. In a manner different from this, the planned start time may be altered as described below, for example.
The alteration is performed on the basis of the planned start time before the alteration. For example, a time after a predetermined time period from the planned start time before the alteration is set as the planned start time after the alteration.
The planned start time is altered based on the traveling history of the vehicle 10. For example, a time period of day during which the use frequency of the vehicle 10 is low is evaluated based on the traveling history, and the planned start time is altered to a time within the time period of day.
The planned start time may be altered so as not to set to a fixed time. For example, the update is started at the time when the execution condition for the update is satisfied after the planned start time before the alteration.
For the alteration of the planned start time, the approval of the user may be sought.

### Execution Condition for Update

In the above embodiment, the case where the execution condition for the software update includes a condition that the vehicle 10 is not traveling has been described as an example. In some cases, another execution condition is not satisfied, so that the software update cannot be started at the planned start time. For example, in some cases, Wi-Fi connection is necessary for the verification of the execution result about the activation. In such cases, the execution condition for the software update includes a condition that the vehicle 10 is positioned at an access point for Wi-Fi at the planned start time. Further, in some cases, the in-vehicle electronic apparatus that is the update object is an apparatus that provides both a service that is executed during the traveling of the vehicle 10 and a service that is executed during the parking, as exemplified by a parking monitoring service. In such cases, when the user does not stop the service that is executed during the parking, the update of the software cannot be executed even when the traveling of the vehicle 10 is ended. In this case, the execution condition for the software update includes a condition that the service that is executed during the parking is stopped. Further, in some cases, the execution condition for the software update includes a condition that the vehicle 10 is not traveling. In any case, the determination in step S140 of FIG. 2 can be performed by determining whether the execution condition for the software update is satisfied at the planned start time.

### Supplement

The technical idea that can be understood from the above embodiments and modifications will be described.

An information processing system according to a first aspect of the present disclosure includes: a determination unit configured to determine whether an update of software in a vehicle is capable of being started at a planned start time of the update, before the planned start time; and an alteration unit configured to alter the planned start time when the determination unit determines that the update is not capable of being started at the planned start time.

In the above aspect, the determination unit may be configured to determine whether the update is capable of being started, based on a traveling schedule for the vehicle.

Further, in the above aspect, the alteration unit may be configured to alter the planned start time, based on a traveling schedule for the vehicle.

An information processing method according to a second aspect of the present disclosure includes: performing a determination on whether an update of software in a vehicle is capable of being started at a planned start time of the update, before the planned start time; and performing an alteration of the planned start time when it is determined that the update is not capable of being started at the planned start time.

In the above aspect, the determination of whether the update is capable of being started may be performed based on a traveling schedule for the vehicle.

Further, in the above aspect, the alteration of the planned start time may be performed based on a traveling schedule for the vehicle.

What is claimed is:

1. An information processing system comprising one or more processors configured to:
determine whether an update of software in a vehicle is capable of being started at a planned start time of the update, before the planned start time; and
alter the planned start time when the one or more processors determine that the update is not capable of being started at the planned start time.

2. The information processing system according to claim 1, wherein the one or more processors are configured to determine whether the update is capable of being started, based on a traveling schedule for the vehicle.

3. The information processing system according to claim 1, wherein the one or more processors are configured to alter the planned start time, based on a traveling schedule for the vehicle.

4. An information processing method comprising:
performing a determination on whether an update of software in a vehicle is capable of being started at a planned start time of the update, before the planned start time; and
performing an alteration of the planned start time when it is determined that the update is not capable of being started at the planned start time.

5. The information processing method according to claim 4, wherein the determination of whether the update is capable of being started is performed based on a traveling schedule for the vehicle.

6. The information processing method according to claim 4, wherein the alteration of the planned start time is performed based on a traveling schedule for the vehicle.

7. A non-transitory storage medium storing instructions that are executable by one or more processors and cause the one or more processors to perform the information processing method according to claim 4.
